(19) United States
(12) Patent Application Publication
(10) Pub. No.: US 2025/0248867 A1
(43) Pub. Date: Aug. 7, 2025

(54) BRAKE MECHANISM

(71) Applicant: Sizewise Rentals L.L.C., Lenexa, KS (US)

(72) Inventors: Troy PARSON, Ellis, KS (US); Duane Edgar WENTE, III, Hays, KS (US); Matthew Ray ISLEY, Hays, KS (US)

(73) Assignee: Sizewise Rentals L.L.C., Lenexa, KS (US)

(21) Appl. No.: 19/035,639

(22) Filed: Jan. 23, 2025

Related U.S. Application Data
(60) Provisional application No. 63/548,559, filed on Feb. 1, 2024.

(51) Int. Cl. A61G 1/02

(52) U.S. Cl. CPC A61G 1/0287

(57) ABSTRACT

An actuation assembly operably engages with a brake system of a wheeled bed allowing actuation of the system by a user to place the brake system in the brake condition, steer condition, and neutral condition using a user-operable powered actuator to move between the brake system conditions, or by depressing foot-operated pedal assembly.

### CROSS-REFERENCE TO RELATED APPLICATIONS

This application claims priority in U.S. Patent Application Ser. No. 63/548,559, filed Feb. 1, 2024, the contents of which are hereby incorporated by reference in its entirety.

### BACKGROUND

The disclosed subject matter relates to wheeled beds.

### SUMMARY

An actuation assembly operably engages with a brake system of a wheeled bed allowing actuation of the system by a user to place the brake system in the brake condition, steer condition, and neutral condition. An electronically controlled actuator is operably connected to the wheels of the bed by a linkage assembly. The linkage assembly includes a cam operably connected to a receiver by a transmission arm.

An actuator connected to the base of the bed is connected to the cam. When the actuator is commanded to retract, the linkage assembly operably connected to the wheels rotate whereby the brake system moves into a brake condition. When the actuator is commanded to extend, the linkage assembly moves the brake system from the brake condition into a neutral condition, followed by a steer condition. Commanding the actuator to retract moves the brake system from the steer condition, into the neutral condition, followed by the brake condition.

### BRIEF DESCRIPTION OF THE DRAWINGS

The present disclosed subject matter is described herein with reference to the following drawing figures, with greater emphasis being placed on clarity rather than scale:

FIG. 1 is an isometric view from above of a bed frame assembly with a brake system embodying principles of the disclosed subject matter.

FIG. 2 is a side elevation view of FIG. 1.

FIG. 3 is an isometric view from below of the base frame.

FIG. 4 is an elevation view from the head of FIG. 3.

FIG. 5 is an isometric view from above of the base frame and brake system.

FIG. 6 is an isometric view of components of the brake system.

FIG. 7 is an isometric view of components of the brake system.

FIG. 8 is an isometric view from below of the foot end of the base frame.

FIG. 9 is an isometric view of the foot end of the base frame.

### DETAILED DESCRIPTION

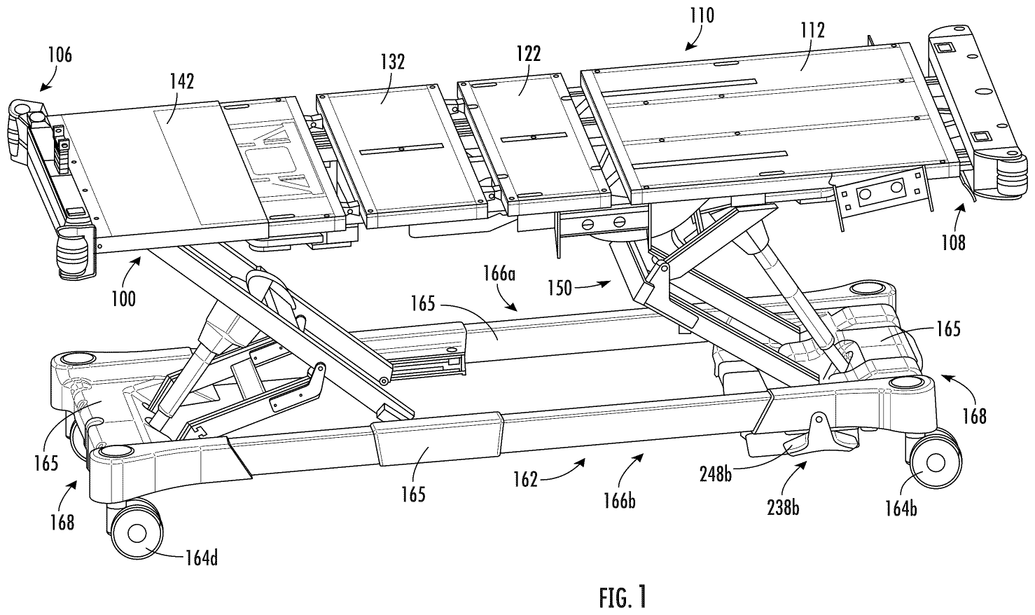

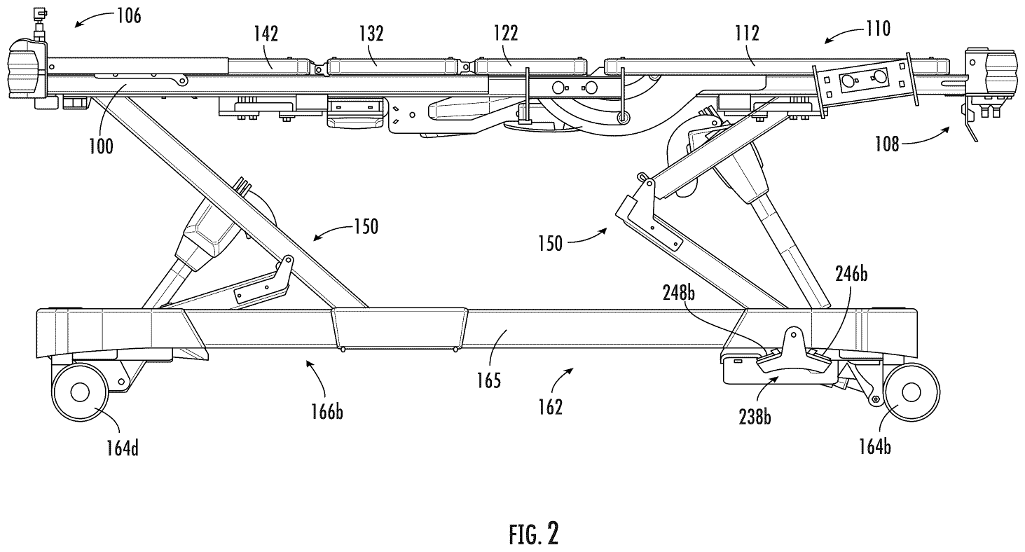

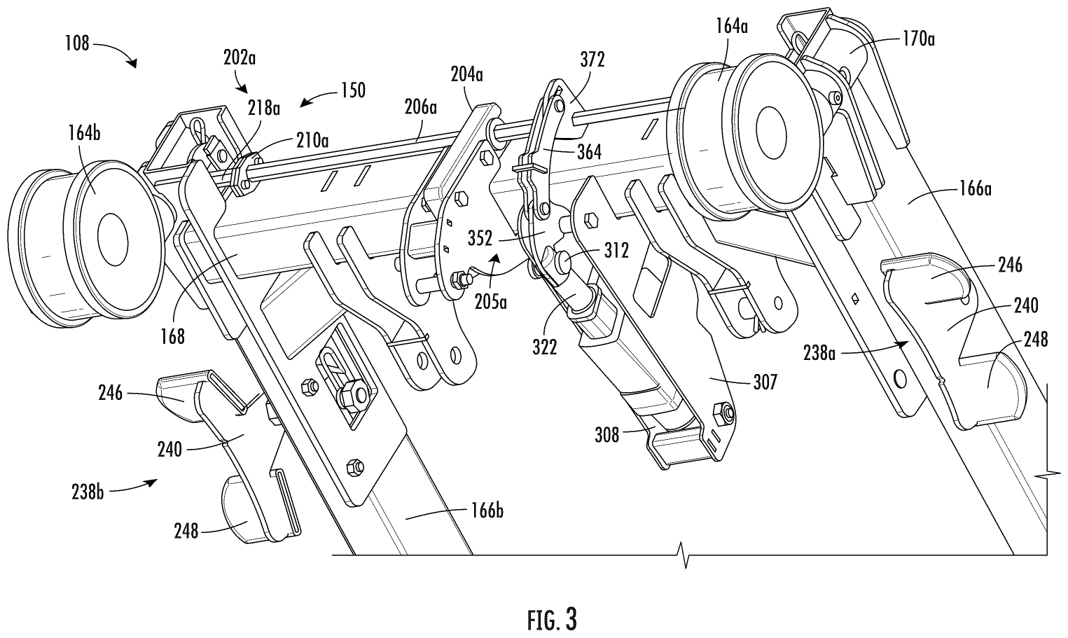

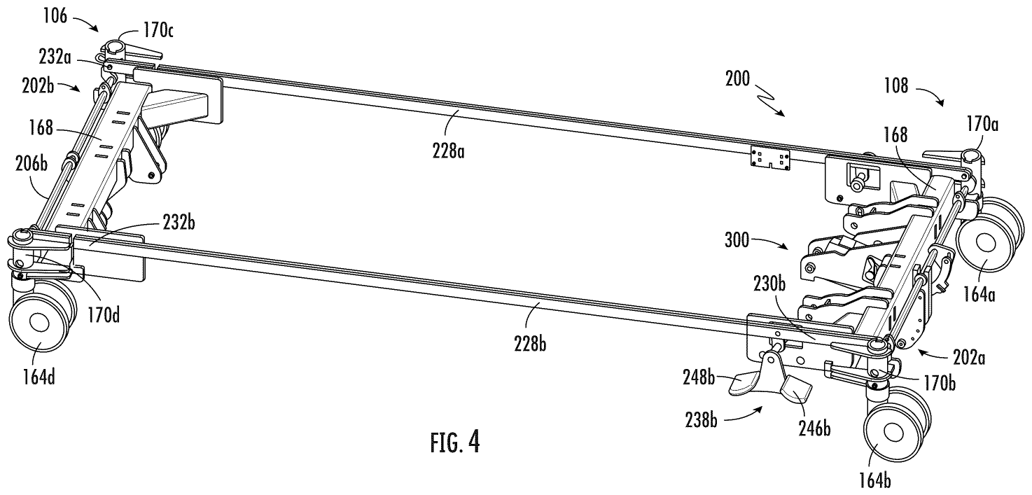

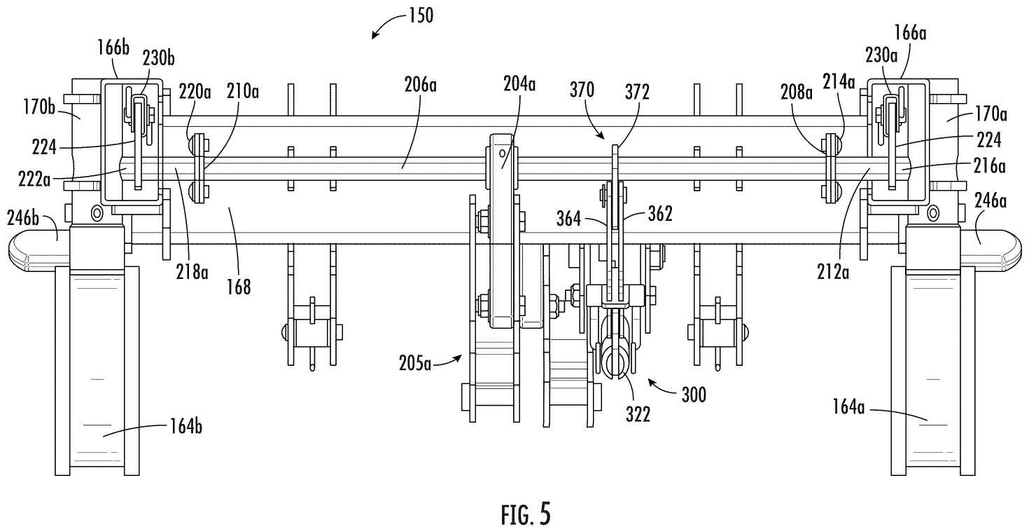

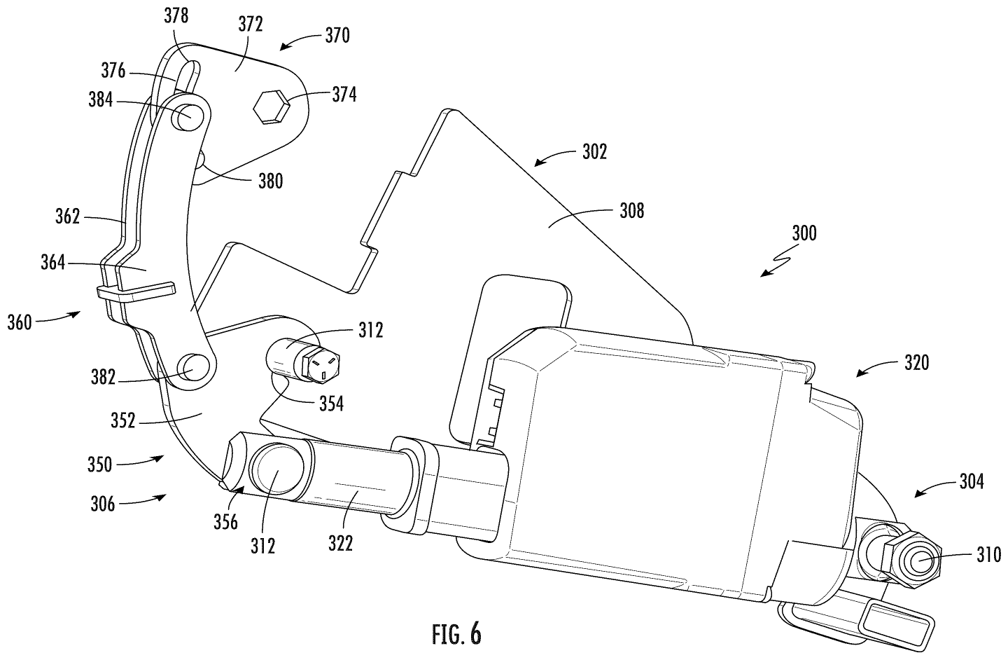

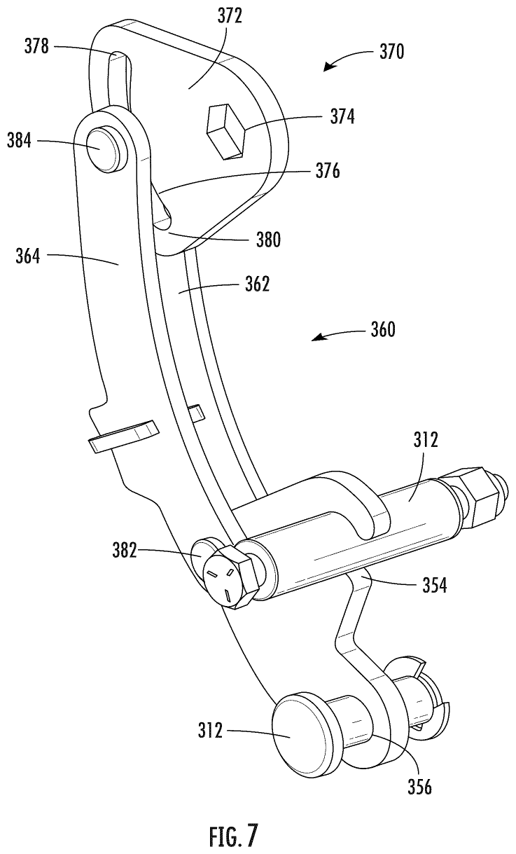

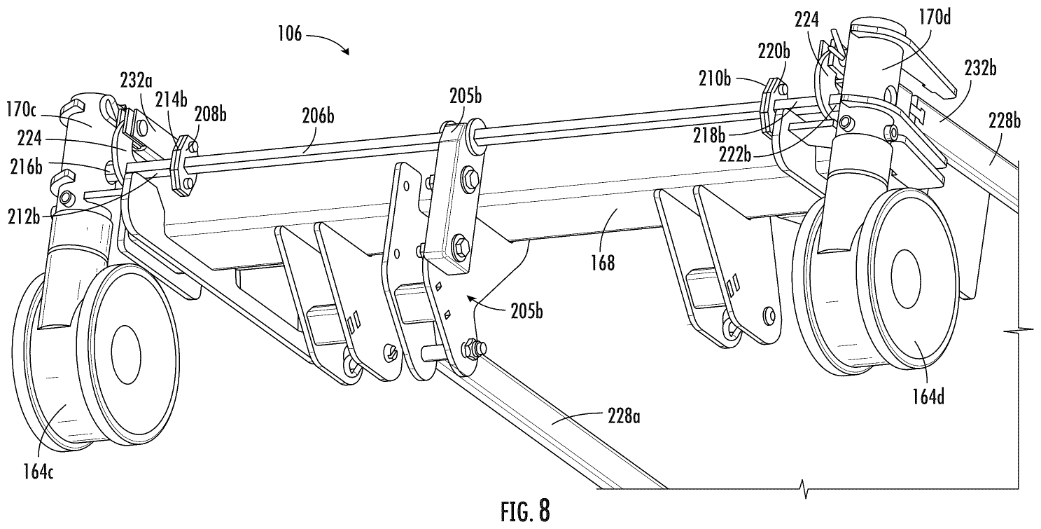

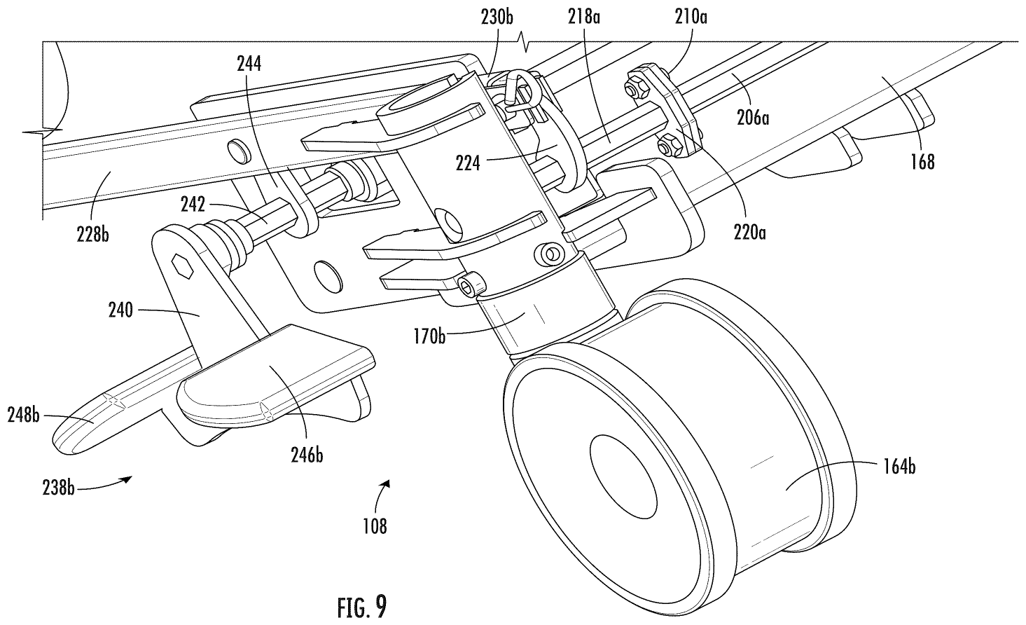

Referring to FIGS. 1-9 and implementation of a brake system 200 for use with a wheeled bed frame assembly 100 is shown and described. Referring to FIGS. 1-2, the bed frame assembly 100 includes components hingedly connected between a foot end 106 and an opposite head end 108 forming a patient support surface 110. The patent support surface 110 is formed by a head section 112, an upper core section 122, a lower core section 132, and a foot section 142. The arrangement of components are articulated to profile a patient from a supine position where the foot section 142, lower core section 132, upper core section 122, and head section 112 provide a generally flat surface parallel with the bed frame assembly 100, to a sitting position where the head section 112 is in an angular position relative to the bed frame assembly 100. The bed frame assembly 100 is connected to a base 162 with ground-contact casters or wheels 164a-d by an elevation assembly 150. In an implementation, the patient is separated from the patient support surface 110 by a mattress. A brake system 200 provides for actuation of the components of the brake assembly connected to the wheels 164a-d when moving the bed frame assembly 100 across a ground surface or keeping the assembly 100 stationary on the ground surface.

The brake system 200 includes an actuation assembly 300 operably connected to the components of a quad-linkage manual brake mechanism, which is then operably connected to wheel assemblies 163a-d. Wheel assemblies 163a-b are located at the head and 108, and wheel assemblies 163c-d are located at the foot end 106. The wheel assemblies 163 include a wheel 164 that rotates about a vertical axis within a housing 170, where the housing 170 connects the wheel to the base frame 162. In the remaining figures the bed frame assembly 100, and the covers 165 concealing the siderails 166, cross member 168, and components of the brake assembly are removed making the components of the brake system 200 more visible. The quad-linkage manual brake mechanism includes transmission arms 228a-b that run within the side rails 166a-b, respectively. The head end 230 and foot end 232 of the arms 228a-b mechanically link transmission shaft 202a-b that are operably connected to wheels 164a-d through housings 170a-d, respectively.

Depressing foot-operated pedal assemblies 238a-b adjacent the side rails 166a-b allow an operator to selectively move the brake system 200 into various conditions. A brake condition is when wheels 164a-d are prevented from rotating across the ground. A neutral condition is when wheels 164a-d are permitted to rotate freely across the ground and are free to rotate about their vertical axis within their housings 170a-d connecting the wheels to the base frame 162. A steer condition is when a first set of wheels consisting of wheels 164a-b are permitted to rotate freely across the ground and are free to rotate about their vertical axis within their housings 170a-b, and where a second set of wheels consisting of wheels 164c-d are permitted to rotate freely across the ground but are prevented from rotating about their vertical axis within their respective housings 170c-d. Preventing the second set of wheels from rotating about their vertical axis makes the wheels fixed, thereby allowing the rolling direction of the second set of wheels to predictably track in a particular direction, thus allowing a user to freely move the end of the bed frame assembly 100 with the first set of wheels to dictate the direction the second set of wheels track, and thereby the direction the bed frame assembly 100 moves.

The pedal assemblies 238a-b are operably connected to the wheels 164a-d by transmission arms 228a-b. The pedal assembly 238 has a body 240 forming a first pedal 246 and a second pedal 248. The body 240 is connected to the transmission arm 228 by a shaft 242 and a bracket 244. Depressing pedals 246, 248 rotates shaft 242, imparting translational movement to the transmission arms 228 passing through the brackets 244. In an implementation, depressing the first pedal 246 placing the pedal assembly 238 into a first condition whereby the first pedal 246 is lower than the second pedal 248 puts the brake system 200 into the brake condition. Depressing the second pedal 248 placing the pedal assembly 238 into a second condition whereby the second pedal 248 is lower than the first pedal 246 puts the brake system 200 into the steer condition. When the first pedal 246 and second pedal 248 are at the same level relative to the ground placing the pedal assembly 238 into a third condition puts the brake system 200 is in the neutral condition.

In an implementation, transmission shafts 202a-b are formed by a central shaft 206 and opposing first and second extensions 212, 218. The central shaft 206 is supported by a bushing within a bracket 204 connected to the crossmember 168 by a mount 205. The central shaft 206 has a first endplate 208 and a second endplate 210, whereby a first extension 212 is connected to the first endplate 208 by an endplate 214, and the second extension 218 is connected to the second endplate 210 by an endplate 220. The endplates may be secured together by fasteners. The first extension 212 has a wheel assembly engagement end 216 opposite endplate 214 that interfaces with hardware within the wheel assemblies 163, and the second extension 218 has a wheel assembly engagement end 222 opposite endplate 220 that interfaces with hardware within the wheel assemblies 163. Upon rotation of the transmission shafts 202, the hardware within the wheel assemblies 163 place the wheels 164 in the respective brake, steer, and neutral conditions. The first and second extensions 212, 218 are operably connected to the transmission arms 228 by transmission links 224. Transmission links 224 are hingedly connected to the transmission arms 228a-b by pins, allowing the translational movement of the arms 228a-b to impart rotational movement to the transmission shafts 202a-b. Sensors can be placed adjacent one or more arms 228a-b to detect the position of the arm 228 providing an indication of the condition of the transmission.

The actuation assembly 300 operably engages with the brake system 200 allowing electronic actuation of the system by a user to place the brake system 200 in the brake condition, the steer condition, and the neutral condition. In an implementation, the actuation assembly 300 is at the head end 108 of the base frame 162 and is controlled by a computer with a processor and a memory and a user interface to input commands to place the brake system 200 in the brake condition, the steer condition, and the neutral condition. In response to operator input commands at the user interface, the actuation assembly 300 can be programmed to place the brake system 200 in the brake condition, the steer condition and the neural condition. In an implementation, the actuation assembly 300 includes a sensor, such as an accelerometer, and the computer is programmed to place the brake system 200 in the brake condition after a predetermined time frame, such as when the bed frame assembly 100 has not moved for a fixed amount of time, for example one minute.

Central shaft 206a is mechanically moved between a brake position, a neutral position, and a steer position by the actuation assembly 300. The assembly 300 generally includes an electronically controlled actuator 320 operably connected to the central shaft 206a by a linkage assembly for rotating the transmission shaft 202a and placing the brake system 200 into the brake condition, into the neutral condition, and into the steer condition. The actuator 320 may be powered by a battery or via electrical power provided to a structure, such as a medical facility or hospital. The linkage assembly includes a cam 350 operably connected to a receiver 370 by a transmission arm 360. The cam 350 is connected to the base frame 162 by a bracket 302.

The bracket 302 formed by a first side plate 307 and adjacent second side plate 308 connects the actuator 320 to the cross member 168 at the head end 108. The actuator 320 is hingedly connected to a first end 304 of the bracket 302 by a hinge pin 310. A shaft 322 extends from the actuator 320 toward the bracket 302 second end 306, and is hingedly connected to the cam 350 by a hinge pin 312. The cam 350 has a body 352 forming a shaft aperture 356 for receiving the hinge pin 312, and an opposing transmission arm aperture for receiving a pin 382 hingedly connecting a transmission arm 360 to the cam 350. A hinge mount 354 receives a hinge tube 312 positioning the cam 350 between side plates 307, 308. The hinge tube 312 rotates about a fastener connecting the cam 350 to the bracket 302 second end 306. The transmission arm 360 is formed by opposing first and second side plates 362, 364. A first end of the transmission arm 360 is hingedly connected to the cam 350 by pin 382, and an opposite second end of the arm 360 is slidably connected to a receiver 370 by a pin 384. The receiver 370 is carried by the central shaft 206a at a transmission shaft aperture 374. The receiver 370 body 372 forms a curved slot 376 opposite a transmission shaft aperture for slidably receiving pin 384 passing therethrough. The slot 376 extends between a second end 380 proximal the hinge tube 312, and an opposite first end 378.

In use, the actuation assembly 300 is commanded to move the brake system 200 into a brake condition without the operator having to depress the pedal assemblies 238a-d. In an implementation, the actuation assembly 300 and the brake system 200 are in a first or neutral condition when the receiver 370 is in a first position, and the pin 384 is disposed between the slot 376 first end 378 and slot 376 second end 380. When a user initiates a brake condition sequence, first the actuator 320 is commanded to move from a shaft 322 first position to a shaft 322 second position by retracting the shaft 322, thereby drawing the pin 384 into contact with the slot 376 second end 380, and then causing the cam 350 to rotate toward the actuator 320 and causing the receiver 370 and central shaft 206a to rotate whereby the brake system 200 moves from the neutral condition into the brake condition. Next in the brake condition sequence, the actuator 320 extends the shaft 322 from the shaft 322 second position to the shaft 322 first position, rotating the cam 350 away from the actuator 320 and moving the pin 384 into a position adjacent the slot 376 first end 378, providing space between the pin 384 and the slot 376 second end 380, thereby allowing rotation of the receiver 370 away from the actuator 320 when an operator depresses any of the second pedals 248 to place the brake system 200 into a neutral condition.

In an implementation, the actuation assembly 300 is commanded to move the brake system 200 from the brake condition into a first neutral condition with a first neutral condition sequence without the operator having to depress the pedal assemblies 238a-d. When the brake system 200 is in the brake condition, the first neutral condition sequence begins with the actuator 320 being commanded to extend the shaft 322 from the shaft 322 first position to a shaft 322 third position whereby the pin 384 is drawn into contact with the slot 376 first end, causing the cam 350 to rotate away from the actuator 320 and causing the receiver 370 and central shaft 206a to rotate whereby the brake system 200 moves into the neutral condition. Next in the first neutral condition sequence, the actuator 320 retracts the shaft 322 from the shaft 322 third position to the shaft 322 first position, rotating the cam 350 toward the actuator 320 and moving the pin 384 into a position where the pin 384 is disposed between the slot 376 first end 378 and slot 376 second end 380.

Further, the actuation assembly 300 is commanded to move the brake system 200 into a steer condition without the operator having to depress the pedal assemblies 238a-d. In an implementation, the actuation assembly 300 and the brake system 200 are in a first or neutral condition when the receiver 370 is in a first position as described above. When a user initiates a steer condition sequence, first the actuator 320 is commanded to move from the shaft 322 first position to a shaft 322 fourth position by extending the shaft 322, thereby drawing the pin 384 into contact with the slot 376 first end 378, and then causing the cam 350 to rotate away from the actuator 320 and causing the receiver 370 and central shaft 206a to rotate whereby the brake system moves from the neutral condition into the steer condition. Next in the steer condition sequence, the actuator 320 retracts the shaft 322 from the shaft 322 fourth position to the shaft 322 first position, rotating the cam 350 toward the actuator 320 and moving the pin 384 into a position adjacent the slot 376 second end 380, providing space between the pin 384 and the slot 376 first end 378, thereby allowing rotation of the receiver 370 toward the actuator 320 when an operator depresses any of the first pedals 246 to place the brake system 200 into a neutral condition.

In an implementation, the actuation assembly 300 is commanded to move the brake system 200 from the steer condition into a second neutral condition with a second neutral condition sequence without the operator having to depress the pedal assemblies 238a-d. When the brake system 200 is in the steer condition, the second neutral condition sequence begins with the actuator 320 being commanded to retract the shaft 322 from the shaft 322 first position to a shaft 322 fifth position whereby the pin 384 is drawn into contact with the slot 376 second end 380, causing the cam 350 to rotate toward the actuator 320 and causing the receiver 370 and central shaft 206a to rotate whereby the brake system 200 moves into the neutral condition. Next in the second neutral condition sequence, the actuator 320 extends the shaft 322 from the shaft 322 fifth position to the shaft 322 first position, rotating the cam 350 away from the actuator 320 and moving the pin 384 into a position where the pin 384 is disposed between the slot 376 first end 378 and slot 376 second end 380.

Having described the disclosed subject matter, what is claimed as new and desired to be secured by Letters Patent is:

1. A brake system for a wheeled bed frame assembly, comprising:
a wheel assembly;
an actuation assembly;
a transmission shaft operably connected to the wheel assembly; and
a linkage assembly, comprising:
a receiver operably connected to the transmission shaft and the actuation assembly.

2. The brake system of claim 1, comprising:
wherein the linkage assembly further comprises:
a transmission arm; and
a cam operably connected to the actuation assembly and the transmission arm.

3. The brake system of claim 2, comprising:
wherein the cam is hingedly connected to the bed frame assembly.

4. The brake system of claim 2, comprising:
wherein a first end of the transmission arm is hingedly connected to the cam; and
wherein a second end of the transmission arm is slidably connected to the receiver.

5. The brake system of claim 4, further comprising:
wherein the receiver forms a slot for receiving the second end of the transmission arm.

6. The brake system of claim 5, further comprising:
a pin connected to the second end of the transmission arm; and
wherein the pin passes through the slot.

7. The brake system of claim 5, further comprising:
wherein the transmission arm is formed by opposing first and second side plates.

8. The brake system of claim 1, further comprising:
wherein the transmission shaft comprises:
a central shaft forming a first end plate;
a first extension extending between an end plate and a wheel assembly engagement end; and
wherein the wheel assembly engagement end is operably connected to the wheel assembly.

9. The brake system of claim 1, further comprising:
a bracket connected to the bed frame assembly; and
wherein the bracket supports the transmission shaft.

10. The brake system of claim 1, further comprising:
wherein the actuation assembly is electronically powered.

11. A brake system for a wheeled bed frame assembly, comprising:
a first wheel assembly;
a first transmission shaft operably connected to the firs wheel assembly;
a second wheel assembly;
a second transmission shaft operably connected to the second wheel assembly;
a transmission arm operably connected to the first transmission shaft and the second transmission shaft;
an actuation assembly; and
a linkage assembly, comprising:
a receiver operably connected to the first transmission shaft and the actuation assembly.

12. The brake system of claim 11, comprising:
wherein the linkage assembly further comprises:
a transmission arm extending between a first end and a second end;
a cam operably connected to the actuation assembly and the transmission arm first end; and
wherein the transmission arm second end is operably connected to the receiver.

13. A method of changing a condition of a brake system for a wheeled bed frame assembly, comprising:
providing a wheel assembly having a neutral condition, a brake condition, and a steer condition;
providing a transmission shaft operably connected to the wheel assembly;
providing an actuation assembly operably connected to the transmission shaft;
moving the actuation assembly from a first position to a second position whereby the wheel assembly moves from the neutral condition to the brake condition; and
moving the actuation assembly from the second position to the first position.

14. The method of claim 13, comprising:
moving the actuation assembly from the first position to a third position whereby the wheel assembly moves from the brake condition to the neutral condition.

15. The method of claim 14, comprising:
moving the actuation assembly from the first position to a fourth position whereby the wheel assembly moves from the neutral condition to a steer condition; and
moving the actuation assembly from the fourth position to the first position.

16. The method of claim 15, comprising:
moving the actuation assembly from the first position to a fifth position whereby the wheel assembly moves from the steer condition to the neutral condition.

17. The method of claim 13, comprising:
providing a linkage assembly, comprising:
a receiver operably connected to the transmission shaft and the actuation assembly.

18. The method of claim 17, comprising:
wherein the linkage assembly further comprises:
a transmission arm, comprising:
a first end of the transmission arm operably connected to the actuation assembly; and
a second end of the transmission arm slidably connected to the receiver.

19. The method of claim 18, comprising:
wherein the receiver forms a slot for receiving the second end of the transmission arm.
